(19) United States
(12) Patent Application Publication
(10) Pub. No.: US 2022/0081325 A1
(43) Pub. Date: Mar. 17, 2022

(54) SYSTEMS AND METHODS FOR ENHANCING EFFICIENCY OF WASTEWATER TREATMENT

(71) Applicant: Matthew Maclay Davis, Rochester, MA (US)

(72) Inventor: Matthew Maclay Davis, Rochester, MA (US)

(21) Appl. No.: 17/024,076

(22) Filed: Sep. 17, 2020

(51) Int. Cl. C02F 1/44; C02F 11/121; B01D 61/08

(52) U.S. Cl. CPC C02F 1/441; C02F 11/121; B01D 61/08; B01D 2317/02; C02F 2301/08; C02F 2201/008; B01D 2311/25; C02F 2301/046

(57) ABSTRACT

A wastewater treatment system is provided for improving the efficiency of existing wastewater treatment plants. In accordance with aspects and embodiments, a wastewater system having a source of wastewater, an effluent, a sludge, a first basin configured to receive the wastewater, and a second basin, in fluid communication with the first basin and configured to receive sludge, may be retrofitted with a closed loop working fluid system. A first membrane system may be arranged in the first basin and a second membrane system may be arranged in the second basin, and a working fluid containing a concentration of at least one solute may be pumped through the first and second membrane systems in a closed loop to enhance overall plant efficiency.

### FIELD OF DISCLOSURE

The present disclosure relates generally to wastewater treatment, and especially to enhancing the efficiency of wastewater treatment plants that treat a wastestream having a high concentration of readily-biodegradable-chemical-oxygen-demand (rbCOD) or plants that treat an isolated, secondary wastestream, which, relative to its primary wastestream, carries a higher combined concentration of rbCOD and/or non-biodegradable-soluble-chemical-oxygen-demand (nbdsCOD) and/or inorganic dissolved compounds. rbCOD includes compounds such as simple sugars, amino acids, volatile fatty acids and alcohols, or any other dissolved compounds which are rapidly removed from solution by the heterotrophic bacteria found in wastewater treatment plants; whereas nbdsCOD includes dissolved compounds that contribute to the chemical-oxygen-demand (COD) concentration, but are resistant to biological breakdown in a conventional treatment system and undergo little reduction in concentration as they pass through the treatment process. The present disclosure provides systems, methods, and processes for increasing the concentration of solids in treated sludge, which advantageously reduces the volume of solids required for handling by treatment plants. The present disclosure may also advantageously lower the peak energy involved in aerating a wastestream with a high concentration of rbCOD, slow the rate of scale buildup caused by wastestreams high in inorganic dissolved compounds, as well as counter some of the operational challenges posed by sludge bulking.

### BACKGROUND

Wastewater treatment plants (WWTP) serve crucial functions in nearly every facet of life. The object of wastewater treatment is to remove contaminates from the influent, i.e., the wastewater, coming into treatment plants and convert it into an effluent that can be returned to the water cycle with minimum impact on the environment. In some specific instances, the object of treatment is to generate an effluent that can be directly reused.

The term wastewater broadly encompasses any water that has been contaminated by human use. Wastewater therefore includes used water from household and domestic activities, used water from industrial and commercial facilities, runoff from agricultural use, surface runoff and stormwater, and sewer inflow. The characteristics of wastewater vary depending on its source. Wastewaters are typically categorized as domestic (wastewater from households), municipal (wastewater from communities, also called sewage), and industrial wastewater, which is the byproduct of manufacturing processes.

Wastewater, depending on its source, can contain physical, chemical, and biological pollutants. These pollutants must be removed in WWTP prior to returning the water to the water cycle. Industrial wastewater in particular includes a wide variety of pollutants. Wastewater generated from industrial site drainage typically contains silt, sand, alkali earth metals, oil, and chemical residues whereas industrial cooling water often includes biocides and is introduced into WWTPs at high temperatures. Wastewater from industrial and manufacturing processes also typically contains pollutants specific to the items being manufactured. For example, acid and base chemical manufacturing produces wastewater with extreme pH and high concentrations of inorganic dissolved compounds, whereas wastewater from oil driller and natural gas production generally contains petro contaminants. Food production plants generate a high volume of wastewater that can include a high concentration of rbCOD and slowly-biodegradable-chemical-oxygen-demand (sbCOD) which includes undissolved biodegradable particulate matter. Each of these wastestreams requires specific treatment. However, many treatment plants rely on similar stages of treatment to produce effluent. Importantly, several commonly treated wastestreams carry a high concentration of rbCOD.

Wastewater treatment plants, regardless of wastewater type or presence of rbCOD content, generally employ a combination of filters and gravity separation techniques to achieve a thickened sludge. In most WWTPs, raw wastewater, known as influent, is first sieved by one or more screens or filters to remove large particles like rocks, sand, and inorganic debris. This screened influent then proceeds to subsequent stages, aerobic, anaerobic, or both, which ultimately results in a mixture which can be settled out in a clarifier and its upper and lower fractions, supernatant and sludge, respectively, can undergo further processing, discharge and disposal. Gravity plays a large role in achieving a suitable effluent, in particular, most WWTPs make use of clarifiers and gravity thickeners. Both of these operations rely on gravity to separate solids from water but are used throughout processes to achieve different results—in the case of a conventional activated sludge plant, the aerobic process is reseeded by a portion of the sludge settling on the bottom of a clarifier immediately following an aeration stage by constantly pumping it back to the beginning of the aeration stage alongside the incoming screened influent from the primary stage—a stream known as primary effluent. Often, more than one clarifier is used in series, with the excess sludge generated from both being steadily removed and treated for efficient disposal. The supernatant from the aforementioned clarifier may flow into a final clarifier which captures many of the remaining slow-to-settle solids and yields an effluent for discharge from the facility, or, depending on the degree of treatment needed, may proceed on to a tertiary treatment stage for a final effluent “polishing,” which may include microfiltration and disinfection.

In contrast to clarifiers, gravity thickeners are designed to concentrate solids, creating a thickened sludge. Often, the sludge produced by clarifiers can still undergo further compaction by gravity alone and must be condensed into a smaller volume for economic disposal. The lower the density of sludge requiring disposal, the more costly. Gravity thickening uses the natural tendency of higher-density solids to settle out of liquid to concentrate the solids. The sludge that forms at the bottom of the gravity thickener becomes further compacted as more solids settle above it. The liquid above the solids layer, the supernatant, can be directed back to one of the clarifiers for further treatment or returned to the primary treatment stage so any excess nutrient content—primarily phosphate, and nitrogen species like ammonium—can be consumed in the subsequent aeration stage. An object of increasing efficiency in wastewater treatment plants (WWTP) is increasing the percent solids (%) in thickened sludge. Thus, the denser a sludge produced by gravity thickening, the more efficiently a plant can operate.

Typically, however, processes upstream of the thickener must be augmented to achieve a naturally denser sludge. With respect to most wastewater treatment, i.e., the treatment of wastewater that includes biodegradable-COD (bdCOD), this is achieved with aeration. Aeration is the process of introducing air into the wastestream to increase the amount of dissolved oxygen (DO) in the solution. Wastewater is fed into an aeration basin where air is continuously injected into the water column. The increase in DO promotes the growth of microorganisms in the wastewater. These microorganisms feed on the organic pollutants, i.e., the bdCOD, in the wastewater and form flocs. The stream leaving the aeration stage, known as a “mixed liquor,” is further processed, generally in one or more clarifiers, where the flocs can settle out by gravity and in their descent capture some fraction of the water column's fine suspended non-biodegradable-particulate-COD (nbdpCOD) content. The flocs settle and compact to form an “activated sludge.” Often, the total dissolved solids (TDS) concentration of water in the stream leaving the aeration stage is equal to that of the effluent and the solution in which the sludge is suspended. The activated sludge in the clarifier can be recirculated back into the aeration basin to reseed the aerobic process and the excess sludge can be diverted out of this cycle and processed downstream for thickening and disposal.

Gravity thickened sludge may also be treated by aerobic digesters to further reduce the amount of solids for discarding and yield a final sludge with a higher %ₛ. Similar to the aeration stage, aerobic digestion is a bacterial process that occurs in the presence of oxygen. Activated sludge is treated with oxygen and bacteria rapidly consume the organic matter in the activated sludge, converting it into carbon dioxide, water and a range of lower molecular weight organic compounds. New bdCOD is not, however, reintroduced to the tank, and the activated sludge biota begin to starve and die and are used as food by other bacteria in a stage of the process known as endogenous respiration.

Aeration and aerobic digestion are, however, a biological process and maintaining optimal results can be challenging. Moreover, aeration and aerobic digestion are energy intensive and thus expensive. To further enhance the processes, some WWTPs introduce enzymes and/or nutrient additives to the aeration stage or directly into an aerobic digester to enhance overall efficiency, with a goal of ultimately increasing the % in the thickened sludge. These chemicals are also costly, some reaching over $70/gallon. There thus exists a market demand for a process able to leverage existing streams, without the need to rely exclusively on high energy, biologically-driven processes, to achieve a favorable thickened sludge.

### SUMMARY OF DISCLOSURE

The present disclosure is directed to enhancing the efficiency of existing wastewater treatment plants. In accordance with aspects and embodiments, a wastewater treatment system is provided, where the wastewater treatment system includes a source of wastewater, an effluent, and a sludge. The system further includes a first basin configured to receive the source of wastewater, where the first basin is in fluid communication with a plurality of downstream wastewater treatment modules, and the first basin also includes a first membrane system. A second basin in the wastewater treatment system is in communication with the plurality of downstream wastewater treatment modules and is configured to hold the sludge. The second basin has a second membrane system, and the first basin and the second basin are in fluid communication with one another and circulate a working fluid containing a concentration of at least one solute.

In accordance with embodiments, the working fluid passes through the first membrane system and is in fluid communication with the source of wastewater. The working fluid also passes through the second membrane system and is in fluid communication with the sludge. The concentration of the at least one solute in the working fluid in the first membrane system is lower than the concentration of the solute in the source of wastewater, and an osmotic pressure gradient occurs across the first membrane system that drives water from the working fluid into the source of wastewater. In accordance with aspects and embodiments, the at least one solute in the working fluid may be sodium chloride.

Similarly, the concentration of the at least one solute in the working fluid in the second membrane system is higher than the concentration of the solute in water present in the sludge, and an osmotic pressure gradient occurs across the second membrane system that drives water from the water present in the sludge into the working fluid.

In accordance with embodiments, the working fluid may be pumped through the first membrane system at a pressure greater than the osmotic pressure across the first membrane system.

In accordance with aspects and embodiments, a wastewater treatment system is provided comprising a mobile trailer, where the mobile trailer has a tank containing a working fluid having at least one solute, a pump in fluid communication with the tank, and first and second membrane systems. The first membrane system is configured to be at least partially submerged in a first tank of an existing wastewater treatment plant and the second membrane system is configured to be at least partially submerged in a second tank of the wastewater treatment plant. The pump on the trailer is configured to circulate the working fluid between the first tank and the second tank. The at least one solute in the working fluid may be sodium chloride

In accordance with embodiments, the first tank of the wastewater treatment plant receives a source of wastewater and the second tank of the wastewater treatment plant receives a sludge having water therein. The trailer pump circulates the working fluid between the first tank and the second tank by pumping the working fluid from the first membrane system and to the second membrane system. The working fluid in the first membrane system is in fluid communication with the source of wastewater and the working fluid in the second membrane system and is in fluid communication with the sludge. The concentration of solute in the working fluid in the first membrane system is lower than a concentration of the solute in the source of wastewater and creates an osmotic pressure gradient across the first membrane system and the concentration of solute in the working fluid in the second membrane system is higher than a concentration of the solute in the water in the sludge and creates an osmotic pressure gradient across the second system. The working fluid may be pumped through the first membrane system at a pressure greater than the osmotic pressure across the first membrane system, and the working fluid may be pumped through the second membrane system at or below osmotic pressure.

In accordance with aspects and embodiments, a wastewater treatment subsystem is provided, the subsystem configured to be installed in an existing wastewater treatment plant, the subsystem comprising a tank configured to hold a working fluid, where the working fluid contains a solute and selected to perform work on a wastewater stream entering the existing wastewater treatment plant. The subsystem further includes at least one pump in communication with the tank, a first membrane system configured to be arranged in a first basin of the existing wastewater treatment plant, and a second membrane system configured to be arranged in a second basin of the existing wastewater treatment plant. The at least one pump is configured to pump the working fluid from the second basin to the first basin.

### BRIEF DESCRIPTION OF THE FIGURES

FIG. 1 is a diagram of a closed loop working fluid system for wastewater treatment in accordance with aspects and embodiments;

FIG. 2 is a schematic of a wastewater treatment plant known in the art;

FIG. 3 is a schematic of a wastewater treatment plant known in the art, as shown in FIG. 2, retrofitted with a closed loop working fluid system, accordance with aspects and embodiments;

FIG. 4 is a schematic of a mobile closed loop working fluid system for wastewater treatment in accordance with aspects and embodiment installed in a wastewater treatment plant known in the art; and

FIG. 5 is a schematic of a mobile closed loop working fluid system for wastewater treatment in accordance with aspects and embodiment installed in a wastewater treatment plant known in the art.

### DETAILED DESCRIPTION

The present disclosure advantageously leverages existing plumbing and systems present in traditional WWTPs to generate an improved thickened sludge, i.e., a sludge having a higher %ₛ. This design can find application in any style of wastewater treatment plant which includes separate vessels for containing a waste sludge and a yet-to-be-treated wastestream. The disclosed system, process, and methods advantageously results in a presscake also having a higher %ₛ. Moreover, the disclosed systems, processes, and methods may advantageously enhance the quality of primary effluent entering the secondary treatment stage by reducing the initial concentration of certain pollutants in wastestreams entering the system and by providing a mechanism for diluting high-strength wastestreams. These benefits may improve operation of existing facilities by reducing fouling.

The disclosed systems, processes, and methods may be used to enhance the efficiency of existing WWTPs or may be employed in new WWTPs. The disclosed systems, processes, and methods may be used in any WWTP, but are most preferably used at plants treating wastewater streams high in rbCOD, or plants which receive a second wastewater stream with a higher solute concentration than its primary wastestream. These streams include, but are not limited to, domestic, municipal, and certain industrial wastes, including for example, landfill leachate and those related to the production of foodstuffs. It is therefore understood that further reference to the “wastewater” herein refers to a wastewater stream with dissolved compounds.

The disclosed systems, methods, and processes leverage a working fluid having a solute in a closed loop to increase the % of a WWTP's waste sludge by exploiting osmotic pressure gradients. The disclosed systems, methods, and processes will be referred to herein, for purpose of convenience, as a “closed loop working fluid system” or where appropriate, as a “closed loop working fluid subsystem.” In accordance with aspects and embodiments, a working fluid having one or more solutes therein is cycled through a closed loop within a WWTP, its concentration, and thus osmotic pressure, varying as it performs work on the system. A first membrane system is submerged in a basin receiving wastewater influent and a second membrane system is submerged in a sludge-containing basin. When circulating through the influent basin, an osmotic pressure gradient is created across the first membrane system as a result of the difference in solute concentrations between the working fluid and the wastewater, where the wastewater has a higher solute concentration and thus a higher osmotic pressure. As a result of the osmotic pressure gradient, water leaves the working fluid, crossing the membranes, and diluting the influent. The working fluid, now having less water and thus a higher relative solute concentration than before entering the influent basin, is directed to the sludge holding basin.

An osmotic pressure gradient is then created across the second membrane system in the sludge basin, which causes dewatering of the sludge. The working fluid, which is now more concentrated and thus has an increased osmotic pressure, has a higher total solute concentration than the solute concentration in the water within the sludge. This in turn creates an osmotic pressure gradient between the water within the sludge and the working fluid that drives water molecules from the water contained within the sludge into the working fluid, thereby dewatering the sludge. The solute concentration in the working fluid, now reduced from having wicked water from the sludge, is recycled back to the influent basin to repeat the cycle.

The first membrane system may be any membrane able to facilitate osmosis. The first membrane system may include a plurality of membrane modules, and the modules may, for example, be a semipermeable membrane module. Alternatively, the first membrane system may include tubing or sheets of regenerated cellulose, cellulose esters, polyamide, polysulfone, or any other suitable material selected by those with skill in the art. The second membrane system may be any membrane able to facilitate osmosis. The second membrane system may also include a plurality of membrane modules, and the modules may, for example, be semipermeable membrane modules. Alternatively, the second membrane system may include tubing or sheets of regenerated cellulose, cellulose esters, polyamide, polysulfone, or any other suitable material selected by those with skill in the art. First and second membrane systems may be selected based on the particular specifications of the wastewater treatment plant in which the disclosed process is being installed, including but not limited to the type of wastewater being treated. Suitable membrane systems for use in the disclosed systems, processes, and methods, will be readily selected by those of skill in the art.

The solute in the working fluid may be selected in accordance with the membrane material chosen and the wastewater stream entering the plant for treatment and may, for example, be a salt, an alkaline earth metal salt, and more specifically, may be sodium chloride. Alternatively, the solute may be a sulfate, an organic salt, or any other solute capable of achieving a concentration gradient sufficient to perform as intended and in conjunction with the membranes selected. In practice, the working fluid may contain a plurality of solutes. In some embodiments, in which it may be advantageous to include more than one solute in the working fluid, two or more solutes may be selected. Additionally, over time, solutes from the wastewater may permeate through the membranes and enter the working fluid. Working fluid composition may further vary depending on the source of solvent. For example, if an effluent from the WWTP plant is used as solvent, the working fluid may contain residual solutes present in the wastewater influent in addition to any solute selected for the purpose of performing work on the treatment system. In some embodiments, a source of fresh water may be used as solvent and a plurality of solutes may be selected for the working fluid. In other embodiments, and if the WWTP is near a source of seawater, seawater may be used as the working fluid solvent. Working fluid may also be dosed with additional agents, including but not limited to biocides and other antifouling agents. The initial composition of working fluid will be readily selected by those of skill in the art based upon factors including, but not limited to, availability of solvents, solutes, and composition of influent wastewater.

Sensors, pressure regulators, and other devices may be employed at various points in the cycle to ensure proper operation. For example, a first sensor may be located downstream of the influent basin and a second sensor may be located downstream of the sludge basin. If the first sensor detects less water content in the working fluid than detected at the second sensor, the pump operating the working fluid cycle will continue to pump. In some embodiments, flow meters may be employed to ensure proper system operation and a pressure regulator may be installed on the line existing the influent basin. Different combinations of suitable sensors, meters, regulators, and membranes will be readily selected by those of skill in the art.

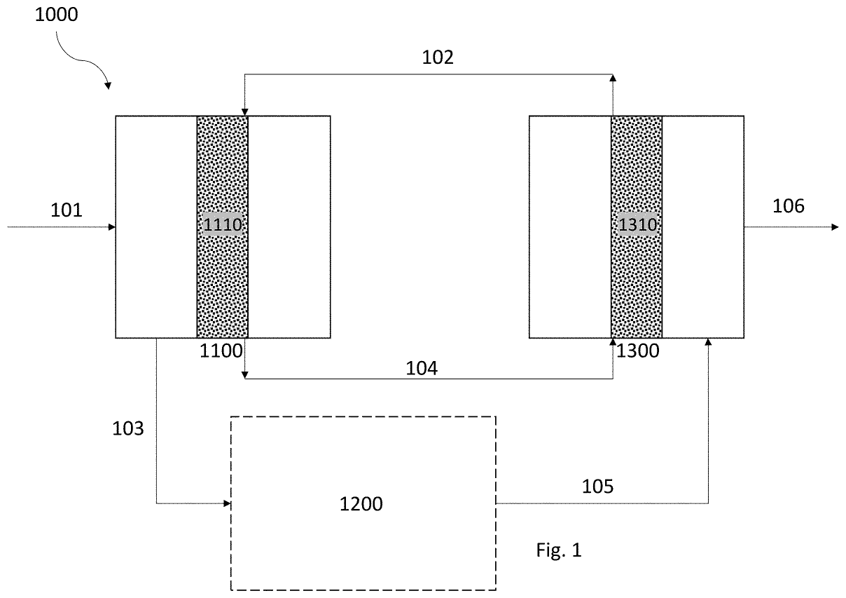

FIG. 1 shows a closed loop working fluid system in accordance with aspects and embodiments. System 1000 has basin 1100 having membrane system 1110 and basin 1300 having membrane system 1310. System 1000 further includes wastewater treatment processes 1200. Wastewater 101 is directed into basin 1100. Wastewater leaves basin 1100 as process stream 103 where it is further treated by wastewater treatment processes 1200 to yield sludge 105 that is held in basin 1300. Basin 1300 and basin 1100 are in direct fluid communication with one another via process streams 102 and 104. In accordance with aspects and embodiments, process stream 102/104 is a solute-containing stream generated by system 1000. The solute may be selected according to the wastewater being treated and may, for example, be a salt, a sugar, or any other suitable solute able to perform in the intended manner. The concentration of solute in process stream 104 is, by design, higher than the concentration of the solute in sludge 105. When process stream 104 and sludge 105 are in basin 1300, water in sludge 105 diffuses through membrane 1310 into solution 104, thereby dewatering the sludge. This process can thus be thought of as a forward osmosis process. Dewatered sludge exits basin 1300 as stream 106. The solute-containing stream, also referred to herein as the working fluid, exits basin 1300 as stream 102. Stream 102 is pumped into membrane 1110. Stream 102, having wicked water out of sludge 105, now contains a lower concentration of solute. While in basin 1100, wastewater in the basin is diluted by the working fluid. The process may be performed under pressure, by for example pumping stream 102 into membrane 1110 under high pressure. The working fluid in system 1000 thus advantageously both dewaters sludge and dilutes the incoming wastewater.

In some embodiments, during operation of system 1000, and particularly when no influent has been introduced to the system for a given period of time, stream 102 entering membrane 1110 may not have a higher solute concentration than wastewater in basin 1100 but may continue to dilute wastewater in basin 1100 due to pressure being applied to the working fluid. In these circumstances, if the pressure applied to the working fluid is sufficient to overcome the osmotic pressure gradient across the membrane, reverse osmosis will occur, and the working fluid can continue to be circulated.

It is to be understood that the operating conditions described above may occur in any of the disclosed systems described herein. Thus, while the working fluid and operation of the disclosed systems, processes, and methods is generally described herein in terms of its concentration of solute, applied pressure may be used to continue the dilution of wastewater via reverse osmosis.

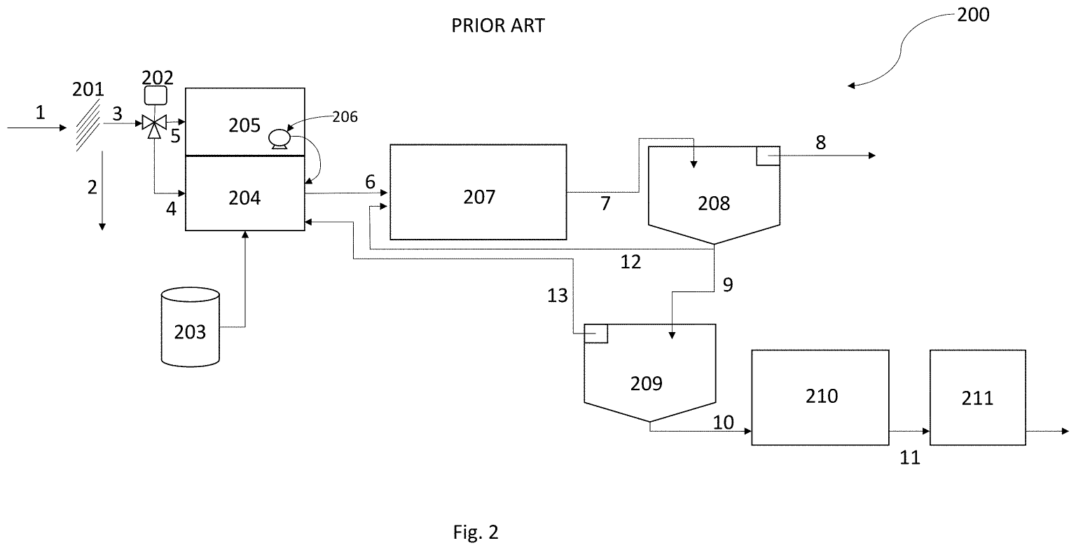

FIG. 2 shows a typical wastewater treatment plant 200 known in the art for the treatment of raw wastewater influent 1 having a high rbCOD concentration. Influent 1 enters the plant and undergoes a filtration process through screen 201, where solids 2 are separated out from the raw influent and discarded. Screened influent stream 3 is then directed through valve and sensor system 202 that directs high-strength streams 5 to high strength basin 205 and streams 4 within normal treatment limits to basin 204. Basin 205 and 204 are in fluid communication with one another via pump 206, and basin 204 is in fluid communication with chemical adjustment and nutrient additive source 203. High strength wastewater in basin 205 is pumped into basin 204, as dictated by fluctuating levels in the raw influent. The wastewater in basin 204 is further adjusted by chemical adjustment and nutrient additive source 203 such that it is suitable for further treatment.

Basins 204 and 205 are both equalization basins, where wastewater is “equalized” such that equalized influent 6, i.e., influent having parameters suitable for downstream treatment, can be pumped from basin 204 into aeration stage 207. Aerated influent exits aeration stage 207 as mixed liquor 7, where it enters clarifier 208. Clarifier 208 may be one or more clarifiers arranged in series or parallel. Sludge 9 settles at the bottom of clarifier 208 and is fed into gravity thickener 209. Return activated sludge (RAS) 12 is fed into aeration stage 207 to reseed the aerobic process. Effluent 8 is collected from clarifier 208.

Gravity thickened sludge 10 exists gravity thickener 209 and is treated in aerobic digester 210 to further reduce the total volume of solids required for handling by WWTP. Supernatant 13 from thickener 209 is directed into basin 204. Sludge 11 treated by aerobic digester 210 is transferred into sludge holding basin 211, where it is held until it is transferred downstream for further dewatering and disposal.

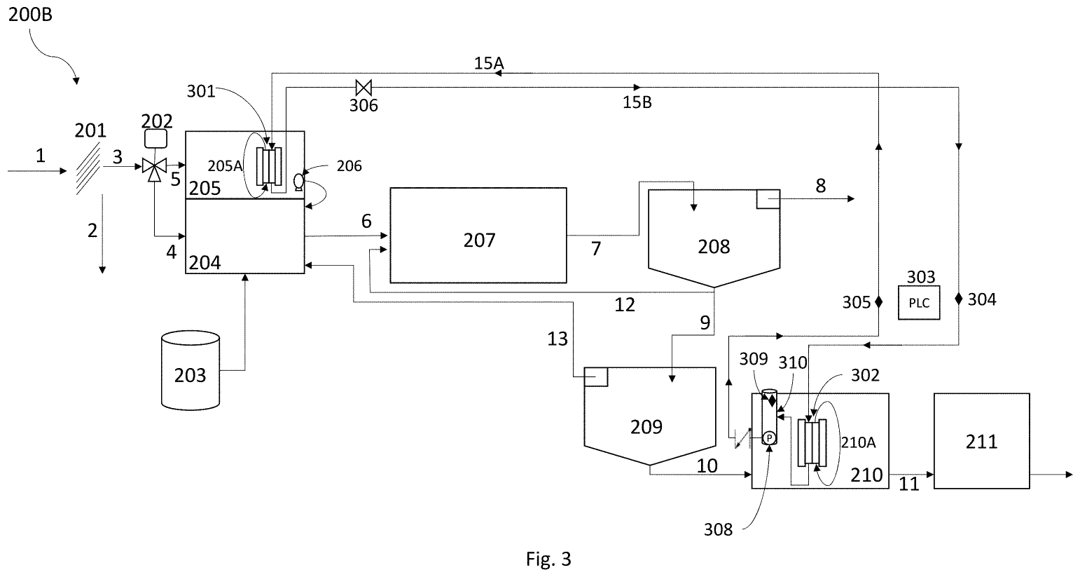

Plant 200 may be readily retrofitted with the systems and methods of the present disclosure to enhance overall efficiency and yield sludge having increased solids concentration. Retrofitted plant 200B having retrofit system 300 is shown in FIG. 3. System 300 employs the systems, methods, and processes as shown in system 1000 and is a closed loop working fluid subsystem. System 300 has semipermeable membrane system 301 in high-strength basin 205 having high strength wastewater 5 and has semipermeable membrane system 302 in aerobic digester 210. System 300 circulates working fluid 15 and is controlled by a programmable logic controller (PLC) 303. PLC 303 receives signals from sensors 304 and 305 and signaler 309 in reservoir 310 and controls valve 306 and pump 308.

Working fluid 15 cycles from basin 205 having membrane system 301 to 210 having membrane system 302 via a closed loop. Working fluid 15 may be any fluid having a solute concentration that causes an osmotic pressure gradient within the system. Working fluid 15 may be a sucrose solution, a sodium chloride solution, or any other suitable solution. Working fluid 15 and the membranes selected for system 300/200B may be selected in conjunction with one another to ensure optimal performance. In some embodiments, biocide may be introduced into the working fluid to prevent membrane fouling.

Working fluid 15 may be held in reservoir 310 and be pumped through system 300 via pump 308. In some embodiments, system 300 may be charged with working fluid by first filling reservoir 310 with water containing a solute to create working fluid 15. Working fluid 15 is pumped into membrane system 301 in basin 205 under an applied pressure, causing water from the working fluid 15A to leave the working fluid and enter the high-strength wastewater in basin 205. Wastewater in basin 205 circulates around membrane system 301 as stream 205A. This operation dilutes the high-strength wastewater in basin 205, making it more suitable for processing. Membrane system 301 in basin 205 may be arranged in series to facilitate higher pressure against the membrane walls, though suitable membrane configurations will be readily ascertained by those of skill in the art. Water from working fluid 15A may cross membrane system 301 as a result of the osmotic pressure difference between the wastewater in basin 205 and the working fluid or, a result of the pressure applied to the working fluid, or a combination of both mechanisms.

Working fluid 15, now exiting basin 205 as 15B, generally has an increased concentration of dissolved solids. Sensor 304 may measure the water content of 15B and or the dissolved solids content of 15B and or the flowrate of 15B and send a signal to PLC 303. If PLC 303 receives a signal from sensor 304 indicating that the water content or flowrate of working fluid 15B is greater than or equal to the water content or flowrate measured by sensor 305 of working fluid 15A, indicating an error in the operation of system 300, then PLC 303 may shut down system 300 by, for example, stopping operation of pump 308. If PLC 303 receives a signal from sensor 304 that the water content or flowrate of 15B is lower than the water content of 15A, indicating proper operation of system 300, PLC 303 may continue to operate system 300.

Working fluid 15B is directed into basin 210 containing sludge 10. Membrane system 302 in basin 210 may be arranged in parallel to reduce pressure on the membrane walls of system 302, however, suitable membrane configurations will be readily ascertained by those of skill in the art. Sludge 210A circulates around membrane system 302. Working fluid 15B will cause water in sludge 10 to enter working fluid 15B as a result of the osmotic pressure difference between working fluid 15B and the water within sludge 10, dewatering sludge 10. Working fluid 15 can then exit basin 210 as 15A and be pumped via pump 308 into membrane system 301 in basin 205 to repeat the cycle.

It will be appreciated that at various points during operation, particularly when the concentration gradient between the working fluid and wastewater in basin 205 becomes insufficient to achieve continued dilution of the wastewater, working fluid 15 may be pumped through basin 205 at a pressure sufficient to overcome the osmotic pressure gradient between working fluid 15A and the wastewater in basin 105, thereby creating a reverse osmosis operation.

Retrofitted plant 200B uses the basin that formerly operated solely as an aerobic digester to house membrane system 302. Many existing wastewater treatment plants, though originally designed to include aerobic digestion, do not use the digester in their treatment processes because the benefits achieved by the aerobic digester are outweighed by the cost of operating it. In these scenarios, the aerobic digester often serves as an additional sludge holding basin, making it particularly suitable for modification in accordance with the disclosed process and systems.

However, the disclosed systems, processes, and methods are readily modifiable for plants having alternative treatments, including aerobic digestion. If, for example, aerobic digestion is beneficial to overall treatment, a WWTP may still employ the presently disclosed methods to further dewater sludge by modifying other basins with the necessary membrane modules and equipment. For example, and as an alternative to the retrofit shown in system 200B, membrane system 302 and other plumbing and equipment could be employed in sludge holding basin 211.

Further, while wastewater treatment plant 200, retrofitted system 200 as 200B, has two equalization tanks, including a high strength wastewater basin where working fluid dilutes the wastewater, only a single equalization basin is needed. For example, and as shown in FIG. 1 system 1000, working fluid can readily dilute influent wastewater in a single basin and be further used to dewater sludge.

Aspects and embodiments of the present disclosure may enhance efficiency of existing WWTP by increasing the density of solids produced by the plant. Sludge produced by WWTPs must be further processed to produce dry solids, generally in the form of a presscake. Dewatered sludge is directed to downstream units that perform further dewatering and compact the solids into as small a volume as possible. This is typically performed by a dewatering belt press and yields a dry solids presscake. Dry solids must then be removed from the premises. While some amount of dry solids may be saleable as agriculture products, a typical WWTP is generally unable to sell all of the solids produced by its plant, requiring the plant to invest in disposal services.

The disclosed processes, systems, and methods advantageously create a denser dry solid presscake. Dry solids not sold are stored in dumpsters for disposal. Often, disposal costs are priced per dumpster. Thus, the more solids able to be fit into a dumpster, the more economically a plant can operate. As a result of the disclosed dewatering process that yields a denser sludge, a denser presscake is able to be produced, and more solids are able to occupy the same volume in a given dumpster. Thus, fewer dumpsters may be required to haul the same amount of dry solids, yielding substantial dry solids handling cost savings.

Moreover, there are significant energy and chemical costs associated with dewatering operations of the prior art. Operation of a dewatering press to yield a presscake is energy intensive and can take 5-7 hours to fill a standard 20 yard dumpster. This operation requires several pounds' worth of chemical polymer per run, as well. The dewatering press in a typical WWTP is run several hundred times annually. Because the runtimes required to press the sludge are shorter for sludge generated from a plant retrofitted with the disclosed system and less chemical may be required to achieve a suitable presscake, the disclosed systems and methods offer energy and other cost savings with respect to dewatering operations.

The disclosed systems, processes, and methods advantageously dilute influent wastewater. This aspect is particularly advantageous in WWTPs that treat wastestreams high in inorganic salts and/or other contaminants that cause scaling and membrane fouling. Scaling and fouling presents an obstacle to plant maintenance. Removing scale from pipes, basins and pumps, and cleaning membranes, requires taking plant systems offline and may, in some instances, require expensive chemical treatments and extensive downtime. The ability to dilute influent while obtaining downstream benefits advantageously reduces the incidence of scaling and fouling and allows plants to stay online longer and extends the lifespan of existing equipment.

In accordance with aspects and embodiments, a trailer or trailer truck may contain the equipment necessary to retrofit an existing wastewater treatment plant with the disclosed closed loop working fluid system. The trailers disclosed are mobile, by for example, connection to a motor vehicle, and may be used to demonstrate the enhanced efficiency obtainable by the disclosed process at existing wastewater treatment plants. The mobility of test systems may aid in encouraging existing treatment facilities to consider plant modifications without having to make any permanent plumbing or equipment changes.

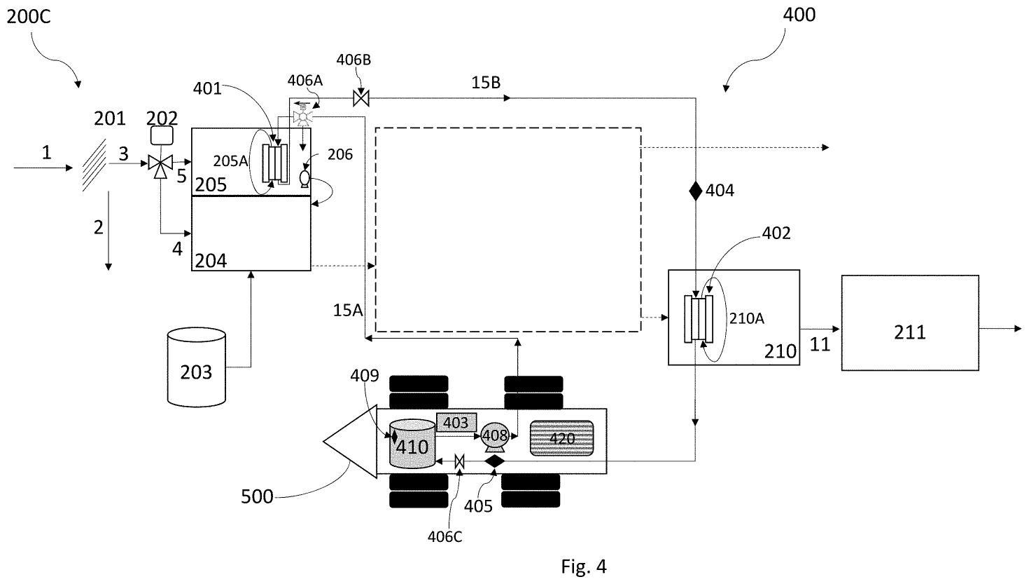

Referring to FIG. 4, trailer truck 500 may be driven to an existing wastewater treatment plant. Trailer truck 500 has onboard all parts necessary to install and operate closed loop working fluid system 400 at an existing WWTP. Trailer truck 500 has membrane storage 420 for holding membrane systems 401 and 402. Trailer truck 500 further has mounted thereon tank 410 containing working fluid, with tank 410 in communication with pump 408. Truck 500 also includes PLC 403.

Membrane systems 401 and 402 can be removed from truck 500 upon arrival at a WWTP and can be deployed in suitable basins. Intermediate treatment modules are omitted from the WWTP shown in FIG. 4 for purposes of convenience and clarity in showing closed loop working fluid system 400. System 500 can then be operated, via power available locally or from truck 500 and with the aid of PLC 403, to activate pump 408 to pump working fluid 15 from tank 410 into basins containing membrane systems 401 and 402. Truck 500 may further include on board a series of pipes, connectors, and fittings such that no plumbing modifications need to be made to an existing facility when system 400 is deployed from truck 500. Tank 410 and pump 408 may be fluidly connected to membrane systems 401 and 402 via plumbing fully contained on truck 500, and flow of working fluid 15 to and from membrane systems 401 and 402 may be regulated by control valves 406A, 406B, and 406C, all of which may be in communication with PLC 403. Upon demonstration of enhanced efficiency via the system 400, WWTPs can decide what membrane systems, sensors, regulators, working fluids, and the like are most appropriate for permanently employing the disclosed process. The mobile closed loop working fluid system may, alternatively, be installed on a truck and pallets, a plurality of trucks, a plurality of trucks and pallets, and/or on other suitable mobile transportation vehicles and devices known in the art.

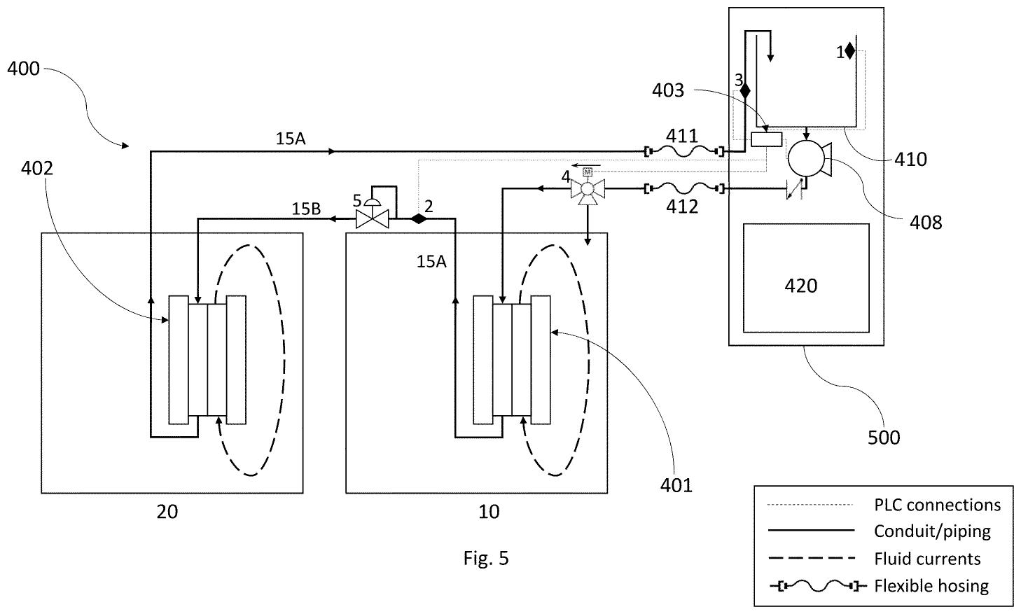

FIG. 5 provides an additional schematic of truck 500 and system 400 installed in a wastewater treatment plant having wastewater basin 10 and sludge holding basin 20. Flexible hosing 411 and 412 may be used connect tank 410 with basins 10 and 20. Tank 410 on truck 500 may arrive at wastewater treatment plant containing dry solute (not shown) and may use a solvent (not shown) available at the plant to generate working fluid 15. This reduces the freight weight of truck 500. In some embodiments, plant effluent may be used as solvent. Solvent is added until the system is “primed,” meaning working fluid is both being pumped from tank into membrane system 401 and is returning to the tank from membrane system 402, thus achieving a closed loop of circulating working fluid 15.

In accordance with embodiments and still referring to FIG. 5, system 400 may include a variety of valves and sensors. Sensor 1 is positioned in tank 410 and sends tank water height signals to PLC 403. If sensor 1 signals that the tank level is too high, PLC 403 will trigger solenoid 3-way valve 4 to discharge into basin 10 if necessary, to reduce tank 410 water level. If the tank water height is too high, this indicates that the system was charged with too much solute at the start of the demonstration.

In contrast, if sensor 1 signals to PLC 403 that the tank level is too low, PLC 403 shuts down operation of pump 408 until the operator recharges the system. A signal that the tank level is too low is indicative of more solute being needed or that pressure should be adjusted in first membrane system 401. Membrane pressure can be adjusted by PLC 403 by engaging backpressure regulator 5.

Sensor 2 measures concentration of solute/solutes in working fluid and/or flowrate. Both flowrate and concentration can assist in evaluating efficiency when compared with the concentration and/or flowrate values obtained from sensor 3. Sensor 3 measures concentration of solute/solutes in working fluid and/or flowrate and may also include a turbidimeter. Turbidimeter 3 advantageously signals if there is a membrane failure, which in turn causes PLC 403 to cease operating system 400 by, for example, stopping operation of pump 408.

Upon completion of demonstration of system 500, solenoid 3-way valve 4 is put into manual operation and pump 408 is allowed to run until the tank is low. Pump 408 is shut down and air is shot backwards through the tank return line. The air displaces fluid in system 400 through 3-way valve 4. The displaced air causes membrane systems 401 and 402 to float to the surface of tanks 10 and 20, which facilitates easy retrieval.

In accordance with aspects and embodiments, one or more control systems may be used to ensure proper operation of the disclosed systems, processes, and methods. As described with respect to PLC 303 of system 300 in FIG. 3 and PLC 403 on truck 500 of system 400 in FIG. 4, a controller may be utilized to regulate the operating parameters of any unit operating in the disclosed closed loop working fluid system/subsystems. Similar controllers to those of PLCs 303 and 403 may be used in various embodiments having different configurations than those explicitly shown in each respective system. Advantageous embodiments in accordance with aspects of the disclosure can involve measuring one or more process conditions of the working fluid and generating one or more control signals based at least partially on the one or more measured process conditions. For example, one or more of the working fluid solute concentration and the working fluid pressure can be measured and transmitted to a controller, which can then generate and transmit a control signal to a solute source or a pressure source to achieve a target or desired value for the working fluid at a given point in the working fluid circulation loop. Moreover, process conditions of influent wastewater and produced sludge may be measured to effectively adjust process conditions of the working fluid to obtain optimal results. The disclosed systems having such process controls may make use of, and tie into, signaling devices already in place at an existing WWTP, or the plant may be further retrofitted with such devices able to provide control signals to a controller.

PLCs 303, 403, and like controllers in alternative embodiments may respond to signals or sensors positions at any particular location within the WWTP, but generally will include and respond to signals and sensors located along the closed loop working fluid systems/subsystems. These controller may be implemented using one or more computer systems which may be, for example, a general-purpose computer such as those based on in Intel PENTIUM®-type processor, a Motorola PowerPC® processor, a Hewlett-Packard PA-RISC® processor, a Sun UltraSPARC® processor, or any other type of processor or combination thereof. Alternatively, the computer system may include specially-programmed, special-purpose hardware, for example, an application-specific integrated circuit (ASIC) or controllers intended for water treatment systems.

The computer system can include one or more processors typically connected to one or more memory devices, which can comprise, for example, any one or more of a disk drive memory, a flash memory device, a RAM memory device, or other device for storing data. The memory is typically used for storing programs and data during operation of the disclosed closed loop system. For example, the memory may be used for storing historical data relating to the parameters over a period of time, as well as operating data. Software, including programming code that implements embodiments of the disclosure, can be stored on a computer readable and/or writeable nonvolatile recording medium, and then typically copied into memory wherein it can then be executed by one or more processors. Such programming code may be written in any of a plurality of programming languages, for example, Java, Visual Basic, C, C#, or C++, Fortran, Pascal, Eiffel, Basic, COBAL, or any of a variety of combinations thereof.

Components of the computer system may be coupled by one or more interconnection mechanisms, which may include one or more busses, e.g., between components that are integrated within a same device, and/or a network, e.g., between components that reside on separate discrete devices. The interconnection mechanism typically enables communications, e.g., data, instructions, to be exchanged between components of the system.

The computer system can also include one or more input devices, for example, a keyboard, mouse, trackball, microphone, touch screen, and other man-machine interface devices as well as one or more output devices, for example, a printing device, display screen, or speaker. In addition, the computer system may contain one or more interfaces that can connect the computer system to a communication network, in addition or as an alternative to the network that may be formed by one or more of the components of the system.

According to one or more embodiments of the disclosure, the one or more input devices may include sensors for measuring any one or more parameters that the system controller may utilized to regulate the operating parameters of any unit or process in the closed loop wastewater subsystem, and the control system may additionally include input devices that measure operating parameters associated with existing WWTP systems. Alternatively, sensors, metering valves, pumps, and other components of the closed loop working fluid subsystem and/or other sensors may all be connected to a communication network that is operatively coupled to the computer system. Any one or more of the above may be coupled to another computer system or component to communicate with the computer system over one or more communication networks. Such a configuration permits any sensor or signal-generating device to be located at a significant distance from the computer system and/or allow any sensor to be located at a significant distance from any subsystem and/or the controller, while still providing data therebetween. Such communication mechanisms may be affected by utilizing any suitable technique including but not limited to those utilizing wireless protocols.

The controller can include one or more computer storage media such as readable and/or writeable nonvolatile recording medium in which signals can be stored that define a program to be executed by one or more processors. The medium may, for example, be a disk or flash memory. In typical operation, the one or more processors can cause data, such as code that implements one or more embodiments of the disclosure, to be read from the storage medium into a memory that allows for faster access to the information by the one or more processors than does medium.

Although the computer system is described by way of example as one type of computer system upon which various aspects of the disclosure may be practiced, it should be appreciated that the disclosure is not limited to being implemented in software, or on the computer system as exemplarily shown. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of the disclosure may be implemented in software, hardware or firmware, or any combination thereof. For example, one or more segments of an algorithm executable by controller 303/403 can be performed in separate computers, which in turn, can be communicated through one or more networks. Although certain representative embodiments and advantages have been described in detail, it will be apparent to those skilled in the art that various modifications and variations can be made in the present disclosure without departing from the scope or spirit of the disclosure. Other embodiments of the disclosure will be apparent to those skilled in the art from consideration of the specification and practice of the systems, processes, and methods disclosed herein. It is intended that the specification and examples be considered as exemplary only.

What is claimed is:

1. A wastewater treatment system comprising:
a source of wastewater, an effluent, and a sludge;
a first basin configured to receive the source of wastewater, the first basin in fluid communication with a plurality of downstream wastewater treatment modules, the first basin further comprising a first membrane system;
a second basin in communication with the plurality of downstream wastewater treatment modules configured to hold the sludge, the second basin further comprising a second membrane system; wherein the first basin and the second basin are in fluid communication with one another and a pump circulates a working fluid containing a concentration of at least one solute.

2. The system of claim 1, wherein the working fluid passes through the first membrane system and is in fluid communication with the source of wastewater.

3. The system of claim 2, wherein the working fluid passes through the second membrane system and is in fluid communication with the sludge.

4. The system of claim 3, wherein the concentration of the at least one solute in the working fluid in the first membrane system is lower than a concentration of the solute in the source of wastewater.

5. The system of claim 4, wherein an osmotic pressure gradient occurs across the first membrane system that drives water from the working fluid into the source of wastewater.

6. The system of claim 5, wherein the concentration of the at least one solute in the working fluid in the second membrane system is higher than a concentration of the solute in water present in the sludge.

7. The system of claim 6, wherein an osmotic pressure gradient occurs across the second membrane system that drives water from the water present in the sludge into the working fluid.

8. The system of claim 2, wherein the working fluid is pumped through the first membrane system at a pressure greater than osmotic pressure across the first membrane system.

9. The system of claim 8, wherein the at least one solute is sodium chloride.

10. A wastewater treatment system comprising:
a mobile trailer, the mobile trailer having a tank containing a working fluid comprising at least one solute, a pump in fluid communication with the tank, a first membrane system, and a second membrane system;
wherein the first membrane system is configured to be at least partially submerged in a first tank of a wastewater treatment plant and the second membrane system is configured to be at least partially submerged in a second tank of the wastewater treatment plant; and wherein the pump is configured to circulate the working fluid between the first tank and the second tank.

11. The system of claim 10, wherein the first tank of the wastewater treatment plant receives a source of wastewater and the second tank of the wastewater treatment plant receives a sludge having water therein.

12. The system of claim 10, wherein the pump circulates the working fluid between the first tank and the second tank by pumping the working fluid from the first membrane system and to the second membrane system.

13. The system of claim 12, wherein the working fluid in the first membrane system is in fluid communication with the source of wastewater.

14. The system of claim 13, wherein the working fluid in the second membrane system is in fluid communication with the sludge.

15. The system of claim 14, wherein the concentration of solute in the working fluid in the first membrane system is lower than a concentration of the solute in the source of wastewater and creates an osmotic pressure gradient across the first membrane system.

16. The system of claim 15, wherein the concentration of solute in the working fluid in the second membrane system is higher than a concentration of the solute in the water in the sludge and creates an osmotic pressure gradient across the second system.

17. The system of claim 16, wherein the working fluid is pumped through the first membrane system at a pressure greater than the osmotic pressure across the first membrane system.

18. The system of claim 17, wherein the working fluid is pumped through the second membrane system at low pressure.

19. The system of claim 18, wherein the at least one solute is sodium chloride.

20. A wastewater treatment subsystem, the subsystem configured to be installed in an existing wastewater treatment plant, the subsystem comprising:
a tank configured to hold a working fluid, the working fluid containing a solute and selected to perform work on a wastewater stream entering the existing wastewater treatment plant;
at least one pump in communication with the tank;
a first membrane system configured to be arranged in a first basin of the existing wastewater treatment plant;
a second membrane system configured to be arranged in a second basin of the existing wastewater treatment plant;
the at least one pump configured to pump the working fluid from the second basin to the first basin.
